(19) United States
(12) Patent Application Publication
(10) Pub. No.: US 2006/0126811 A1
(43) Pub. Date: Jun. 15, 2006

(54) System and method for routing calls

(75) Inventors: Robert R. Bushey, Round Rock, TX (US); Benjamin Anthony Knott, Cedar Park, TX (US); John Mills Martin, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/010,633

(22) Filed: Dec. 13, 2004

(51) Int. Cl. H04M 15/06

(52) U.S. Cl. 379/142.01

(57) ABSTRACT

A method of processing call is disclosed. In a particular embodiment, the method includes prompting a caller for information. The method further includes selecting a resource to process the information, determining a delay time to estimate when the resource will be available to the caller, providing a message to the caller having a time duration based on the delay time, and processing the caller's information.

### FIELD OF THE DISCLOSURE

The present disclosure relates generally to automatic call routing systems and, more particularly, to call transfers in an automatic caller routing system.

### BACKGROUND

Automatic call routing (ACR) systems are commonplace for businesses that process high call volumes. A goal of an ACR system is to determine why a customer is calling and then to route the call to an appropriate service department. In order for an ACR system to properly route calls, the ACR system generally interprets the intent of the customer, identifies the type of the customer call, and selects a correct routing destination. During an ACR procedure a caller may be routed utilizing many different resources. For example, a main ACR system may prompt a caller, receive a response and based on the response route the caller to another ACR system. Additionally, during the routing procedure an ACR system may need to retrieve information from a database resource in order to process the call. Resources that provide information are often busy when an ACR system requests service. Likewise, a “downstream” system or resource may be busy when the main ACR system is attempting to transfer the call. If a “downstream” system or resource is unavailable a caller can experience long periods of silence. When a caller experiences more than a few seconds of silence, they often think that they are misrouted or “lost” in the system, and the caller may hang up and retry the call. A system with lower abandon call rates would operate more efficiently and have a lower operating cost. Accordingly, there is a need for an improved method and system for routing calls.

### BRIEF DESCRIPTION OF THE DRAWINGS

FIG. 1 illustrates a simplified configuration of a telecommunication system;

FIG. 2 illustrates a simplified configuration of an automatic call routing system; and

FIG. 3 is a flow diagram that illustrates a method of call processing.

### DETAILED DESCRIPTION OF THE DRAWINGS

A method of processing call is disclosed. In a particular embodiment, the method includes prompting a caller for information. The method further includes selecting a resource to process the information, determining a delay time to estimate when the resource will be available to the caller, providing a message to the caller having a time duration based on the delay time, and processing the caller's information. Based on the delay time the method can select a message or combination of messages to keep the caller engaged with the routing system. When the delay time expires the system routes the call to the next resource. A predicted delay time can be determined according to a historical average delay of the resource. The system and method can provide a message having content that relates to the delay time and the selected resource.

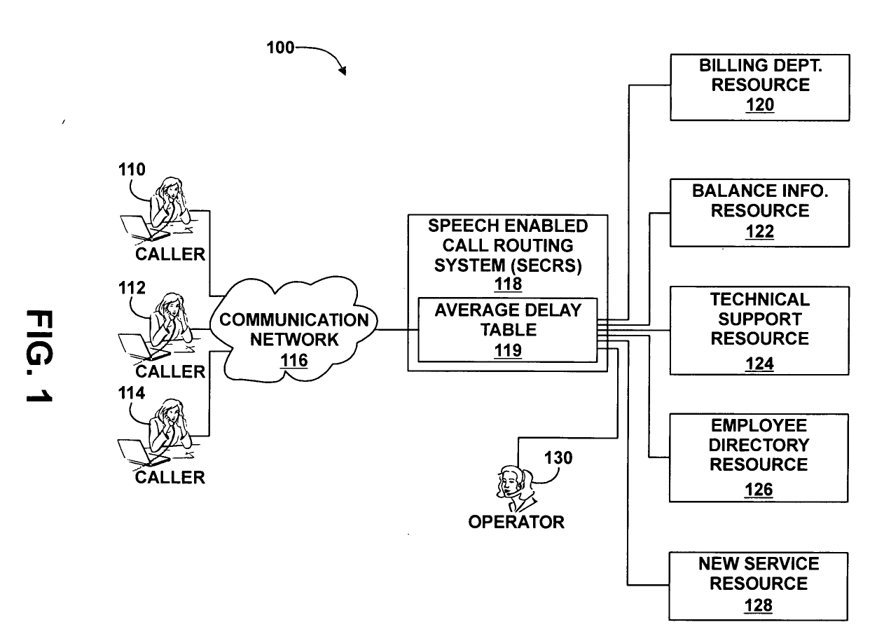

Referring to FIG. 1, a communications system 100 is illustrated. The communications system 100 includes a speech enabled call routing system (SECRS) 118, such as an interactive voice response system, and a plurality of potential call destinations. Generally, illustrative callers 110, 112, and 114 are routed to destinations, such as a billing department 120, an account balance department 122, a technical support department 124, an employee directory 126, or to a new customer 128 department. The caller may also, in certain cases be routed to an operator 130. The communication network 116 receives calls from a variety of callers, such as the illustrated callers 110, 112, and 114 who desire to receive information. In a particular embodiment, the communication network 116 may be a public telephone network or may be a voice over Internet protocol (VoIP) type network. The SECRS 118 may include components, and may include an average delay determination table 119. In a particular embodiment, the average delay table 119 is continually updated to track the availability (average delay time between a caller request and a response) of systems or resources coupled to the SECRS 118.

The SECRS 118 is coupled to, and may request service from, any of the resources as shown. In addition, the SECRS 118 may route calls to a “live” resource, such as an agent illustrated by operator 130. An illustrative embodiment of the SECRS 118 may be a call center having a plurality of agent terminals attached. Thus, while only a single operator 130 is shown, it should be understood that a plurality of different agent terminals or types of terminals may be coupled to the SECRS 118, such that a variety of agents may service incoming calls. In addition, the SECRS 118 may be an automated call routing system.

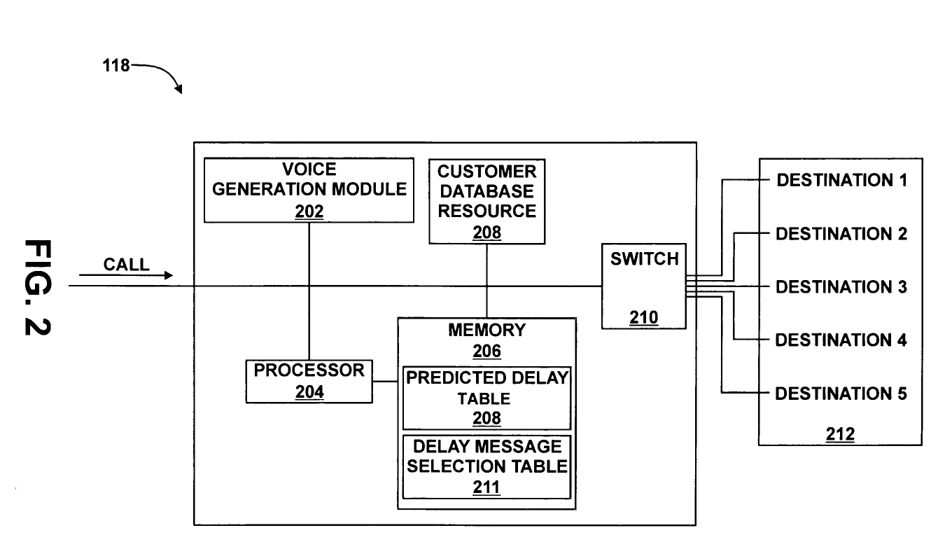

Referring to FIG. 2, a simplified block diagram of an illustrative embodiment of the SECRS 118 in FIG. 1 is depicted. The SECRS 118 can include a voice generation module 202, a processor 204, a memory 206, and a switch 210. A delay message selection table 211 and a predicted delay table 208 can be included in the memory 206. The SECRS 118 can be coupled to a plurality of destinations, such as those illustrated in area 212. The destinations 212 can include resources, such as those illustrated by items 120-128 in FIG. 1. The processor 204 can control call processing by retrieving and executing instructions from the memory 206 and by activating the voice generation module 202 to produce audio for an incoming call. Processor 204 can also control switch 210 to route the call to one of the destinations. The processor 204 can monitor the resources and calculate an average delay time that estimates the “time till availability” of each resource to create a predicted delay (i.e. the predicted delay is an estimate of the time that will pass before the resource is available). Alternately, the predicted delay time can be an estimate of the time when a resource will finish processing a pending request. The predicted delay time can be stored in the predicted delay table 208. The predicted delay table 208 can be linked to delay message selection table 211, such that a predicted delay in table 208 can be associated with a delay message or a series of delay messages in selection table 211.

If the destination 212 to which the call will be routed has an associated delay entry as provided by predicted delay table 208, the processor 204 can access message table 211 and provide the voice generation module 202 with a message to announce a delay duration based on the predicted delay time. The message can also have content that notifies the caller of delays and forthcoming events. The voice-generating module 202 that initially addressed the call can inform the caller with a series of predetermined prompts or messages to keep the caller engaged during the routing process. If the desired resource becomes available before the delivery of the selected delay message to the caller, the system can interrupt the delay message.

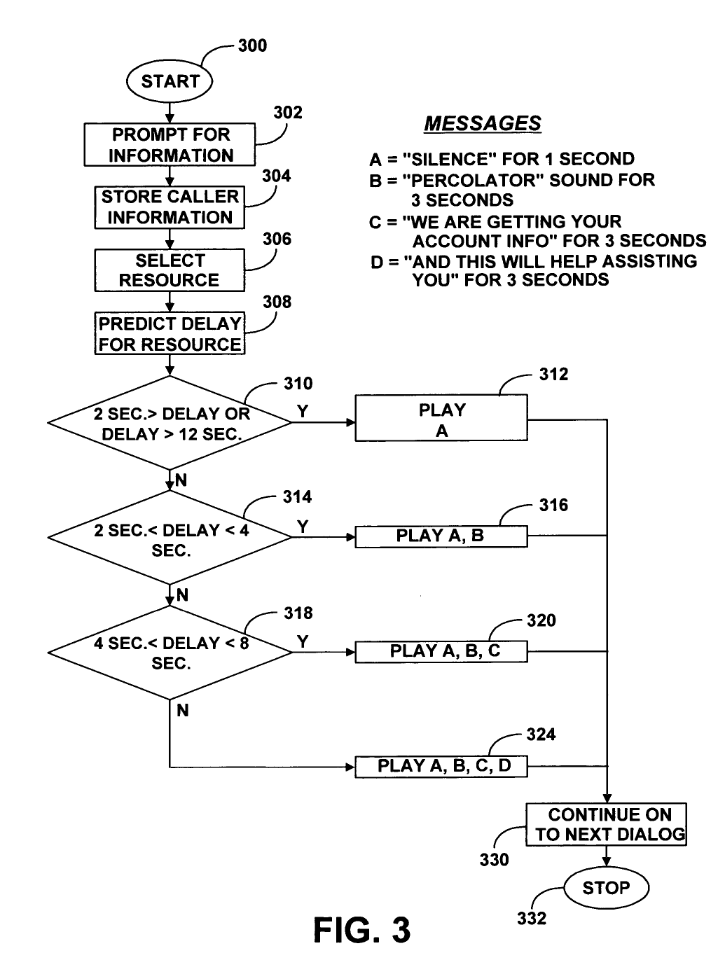

Referring to FIG. 3, a method of operation that may be used in connection with the system 100 of FIG. 1 is illustrated. The method starts at 300 and proceeds to step 302 where a caller is greeted and prompted for information. The prompt could be for caller data or to determine a call request. Caller information is received at step 304 and the method selects a resource the can continue processing of the call based on the received caller information, at step 306. A resource can generally be defined as computer hardware and/or software that supplies data or processes data for a caller. The method predicts when the selected resource will be available and provides a predicted delay time for the selected resource at step 308.

If the predicted delay is less than 2 seconds or greater than 12 seconds, at decision step 310, the process proceeds to step 312 where the method plays message A, which is silence for 1 second. Message A can have a time duration responsive to the predicted delay. Messages A-D in the text of FIG. 3 are provided as non-limiting examples and alternate messages may be used. The method then proceeds to step 330 where dialog is continued. The caller information can be transferred with the caller to the selected resource or to the routing destination.

When the predicted delay is greater than 12 seconds, the method can bypass the selected resource and select another resource such as a second resource to continue processing the call. If the actual delay or the measured delay is greater than the predicted delay, then the method may also select an alternate resource. Further, the process may retry the bypassed resource at a later time.

If the predicted delay is greater than 2 seconds, at decision block 310, the process proceeds to decision step 314, wherein if the delay is between 2 and 4 seconds, the process proceeds to step 316 and the system plays concatenated messages A and B (silence and then a percolation sound). A percolating sound can be a quick series of tones to simulate a computer that is processing data. After the percolating message is played, the process proceeds to step 330 and the dialogue is continued. Concatenating or combining message A and message B in series can provide a message having a time duration based on the predicted delay time.

When the predicted delay is greater than 4 seconds, at decision step 314, the process moves to decision step 318, where, if the predicted delay is between 4 and 8 seconds, the process proceeds to step 320. At step 320, messages A, B, and C, (silence, percolation, “We are getting your account information,” and silence) are concatenated and played. This combination of messages can provide an 8-second delay. Combining messages A, B, and C provides a message having a time duration based on the predicted time delay. The dialog is continued at step 330.

When the predicted delay is greater than 8 seconds, at step 318, the process proceeds to step 324 where A, B, C, D, and then A are played (silence, a percolator sound, “We are getting information on the account,” “and this will help assisting you,” and silence). Thus, in accordance with step 324 the method will provide an informed delay for a total of 11 seconds and forward the caller to the next dialog as illustrated in block 330.

The two-second and 12-second metric, as well as other metrics can be altered without parting from the scope of the present disclosure. For example, the max delay (12 seconds in FIG. 3) can be set to different values. If a resource becomes inoperable, the delay time can be set to the maximum value, and the resource is effectively skipped or by-passed as the method proceeds to the next dialog, as in step 330.

Many different methodologies can be utilized to predict a delay time for a resource. In one embodiment the method tracks the recent delay history of each resource and provides a predicted delay time based on previous delays encountered by systems requesting the resource. The amount of historical data utilized to predict the delay can be adjusted to increase the accuracy of the predicted delay time. The amount of historical data can be defined utilizing a past time frame such as the past “X” minutes or a past number of calls such as the past “N” calls. If a small history sample, such as the past 100 calls, is utilized to determine the average delay then the predicted delay might be sensitive to fluctuations, whereas if the number of calls utilized to predict the delay were 10,000, the predicted delay may be less sensitive to system dynamics. A system that handles 45,000 calls per hour utilizing a 10,000-call history metric averages a 13-minute history, wherein a 100-call history metric averages an 8-second history. A routing process may need services from multiple resources and predicted delays from the multiple resources can be summed together. Thus, when a caller requests account data, the present system can predict a delay for a customer database server to retrieve the data and predict a delay for a speech system to present the data verbally to the caller and determine a cumulative delay.

Research has shown that callers increase their abandon rate when they believe that their call is being sent to an incorrect destination. With the disclosed delay based informed call routing system and method, a call center would experience significant reduction in dropped calls by keeping the callers' attention during the call routing procedure.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of processing a call comprising:
prompting a caller for information;
selecting a resource to process the information;
determining a delay time to estimate when the resource will be available to the caller; and
providing a message to the caller having a time duration based on the delay time.

2. The method of claim 1, further comprising determining the delay time based on historical data and processing the information.

3. The method of claim 1, wherein the message includes content responsive to the determined delay time.

4. The method of claim 1, further comprising bypassing the selected resource if the determined delay time exceeds a predetermined threshold.

5. The method of claim 4, further comprising locating a second resource responsive to the information.

6. The method of claim 1, further comprising concatenating at least a first message and a second message to provide the message having the time duration based on the delay time.

7. The method of claim 3, wherein when a measured delay time is greater than the delay time, routing the call to a second resource.

8. The method of claim 2, wherein the historical data includes an historical average delay time that is determined utilizing a predetermined number of calls.

9. The method of claim 2, wherein the historical data includes an historical average delay time that is determined utilizing a predetermined time delay.

10. The method of claim 1, further comprising transmitting the information to the selected resource.

11. The method of claim 1, further comprising notifying the caller of forthcoming events.

12. The method of claim 1, further comprising retrieving the message from a predicated time delay message table responsive to the determined delay.

13. The method of claim 1, further comprising combining a first delay time from a first resource with a second delay time from a second resource to determine the delay time.

14. The method of claim 1 further comprising updating a predicted delay table based on actual delays in accessing the resource.

15. The method of claim 1, further comprising routing the caller to a destination.

16. The method of claim 15, wherein the resource is at a different location than the destination.

17. A system comprising:
a voice generation module to prompt a caller for call information;
memory configured to store the call information;
a processor coupled to the voice generation module and the memory, the processor to select a resource to process the call information, the processor configured to predict a delay time when the selected resource will be available; and
wherein the voice generation module is to provide a message to the caller having a time duration responsive to the delay time.

18. The system of claim 17, wherein the processor retrieves historical data to determine the delay time.

19. The system of claim 17, wherein the historical data is collected from a predetermined number of calls.

20. The system of claim 17, wherein when the delay time is greater than a predetermined time the processor directs the call to be routed to a second resource.

21. The system of claim 17, wherein the delay time is an average delay time of accessing the selected resource for a past number of calls.

22. The system of claim 17, further comprising a switch responsive to the processor for routing the call to a destination.

23. The system of claim 17, wherein the processor includes logic to concatenatie at least a first message and a second message to provide a message having time a duration based on the delay tine.

24. A method of receiving call service comprising:
providing information to a call center;
selecting a resource to process the information;
receiving a message having a time duration based on a delay time that is an estimate of when the resource will be available.

25. The method of claim 24, wherein the delay time is responsive to historical data.

26. The method of claim 24, further comprising receiving processed information from the resource.
